(19) United States
(12) Patent Application Publication
(10) Pub. No.: US 2026/0254534 A1
(43) Pub. Date: Aug. 27, 2026

(54) A METHOD FOR REDUCING STANDBY POWER CONSUMPTION IN AN OPTICAL WIRELESS COMMUNICATION SYSTEM

(71) Applicant: SIGNIFY HOLDING B.V., EINDHOVEN (NL)

(72) Inventor: ANTENEH ALEMU ABBO, EINDHOVEN (NL)

(21) Appl. No.: 18/874,707

(22) PCT Filed: Jun. 12, 2023
(86) PCT No.: PCT/EP2023/065659

§ 371 Date: Dec. 13, 2024

(30) Foreign Application Priority Data
Jun. 16, 2022 (EP) 22179346.6

(51) Int. Cl. H04B 10/564; H04B 10/11; H04B 10/54

(52) U.S. Cl. CPC H04B 10/564; H04B 10/11; H04B 10/54

(57) ABSTRACT

An optical transmitter (100) comprising a light source (210) configured to emit light for optical wireless communication based on an input signal comprising a data signal to be transmitted via the optical transmitter (100); a power switch (220) configured to turn on or off a power supply to the light source (210); a detector (230) configured to: detect the input signal on a signal path of the optical transmitter (100); and send a first trigger signal related to a start of transmission, SoT, of the input signal to a switch controller (240); the switch controller (240) configured to control the power switch (220) to power on the light source (210) upon receiving the first trigger signal; wherein the optical transmitter (100) is configured to: prevent the data signal being transmitted during a first time interval after powering on the light source (210); and transmit the data signal during a second time interval subsequent to the first time interval; wherein the first time interval is determined based on a settling time of the light source (210).

### FIELD OF THE INVENTION

The invention relates to the field of optical wireless communication, such as Li-Fi communication. More particularly, various apparatus, systems, and methods are disclosed herein related to reducing standby power consumption in an optical wireless communication system.

### BACKGROUND OF THE INVENTION

To enable more and more electronic devices like laptops, tablets, and smartphones to connect wirelessly to the Internet, wireless communication confronts unprecedented requirements on data rates and link qualities, and such requirements keep on growing year over year, considering the emerging digital revolution related to Internet-of-Things (IoT). Radio frequency technology like Wi-Fi has limited spectrum capacity to embrace this revolution.

In the meanwhile, optical wireless communication (OWC) is drawing more and more attention with its intrinsic security enhancement and capability to support higher data rates over the available bandwidth in visible light, Ultraviolet (UV), and Infrared (IR) spectra. Depending for example on the wavelengths used, such techniques may also be referred to as coded light, Light Fidelity (LiFi), visible light communication (VLC) or free-space optical communication (FSO). OWC or Li-Fi is directional and shielded by light blocking materials, which provides it with the potential to deploy a larger number of access points, as compared to Wi-Fi, in a dense area of users by spatially reusing the same bandwidth. These key advantages over wireless radio frequency communication make OWC or Li-Fi a promising secure solution to mitigate the pressure on the crowded radio spectrum for IoT applications and indoor wireless access. Other possible benefits of Li-Fi may include guaranteed bandwidth for a certain user, and the ability to function safely in areas otherwise susceptible to electromagnetic interference. Therefore, Li-Fi is a very promising technology to enable the next generation of immersive connectivity.

WO2022008240A1 relates to a trigger based optical wireless communication system, such that to establish a high-speed optical link, the end point device first sends an optical trigger signal to the access point in the low power state. The access point switches to the normal operation state only when a valid trigger signal is identified after detecting the optical trigger signal.

### SUMMARY OF THE INVENTION

To reduce power consumption, it is desirable to keep part of an optical transmitter in sleep mode, such as an optical front-end, when there is no transmission. This may be achieved by observing on a cable interface signal levels of an input signal to be transmitted. Power saving is beneficial to both battery powered end devices/terminals and ceiling mounted optical access points.

In view of the above, the present disclosure is directed to methods, apparatus, and systems for providing improved uplink communication in an optical wireless communication system. More particularly, the goal of this invention is achieved by a method for allocating uplink radio resource as claimed in claim 1, by an optical access point as claimed in claim 11, and by a computer program as claimed in claim 15.

In accordance with a first aspect of the invention an optical transmitter is provided. An optical transmitter configured to transmit a data signal for optical wireless communication, the optical transmitter comprises a light source configured to emit light for optical wireless communication based on an input signal comprising the data signal to be transmitted via the optical transmitter; a power switch configured to turn on or off a power supply to the light source; a detector configured to: detect the input signal on a signal path of the optical transmitter; and send a first trigger signal related to a start of transmission, SoT, of the input signal to a switch controller; the switch controller configured to control the power switch to power on the light source upon receiving the first trigger signal. The optical transmitter is configured to prevent the data signal being transmitted during a first time interval after powering on the light source; and transmit the data signal during a second time interval subsequent to the first time interval; wherein the first time interval is determined based on a settling time of the light source.

The optical wireless communication may be carried out in visible light, Ultraviolet (UV), and Infrared (IR) spectra. Thus, the optical wireless communication may also be called a Li-Fi communication or a Visible Light Communication (VLC). The light source or light emitter may a light-emitting diode (LED).

Since the light source is the most power consuming component in an optical transmitter, it is desirable to keep the light source in an off state or sleep state as long as possible, such that the light source is only powered up for transmission. However, depending on the type of light sources being used, there is typically a delay, or so-called settling time, for the light source from being power up to getting into a stable state for communication.

The settling time is a delay required by the light source to settle at an output level suitable for optical wireless communication after powering up. It is important to avoid the data signal being transmitted during the settling time. Otherwise, part of the data signal will not be detected by a remote receiving device, since the output power of the optical transmitter is simply too low for supporting the link.

The detector is used to observe the input signal and to provide the trigger signal to the switch controller earlier before the data signal actually arrives at the input of the light source. And then, the situation that the data signal is emitted by the light source during the settling time is avoided.

The optical transmitter may be a standalone device or integrated into another electronic device, such as a laptop, a tablet, a smartphone, a TV, a display device, a luminaire, etc. The optical transmitter may also be deployed as an end device/terminal or an optical access point for providing connections to a plurality of end devices.

Beneficially, the detector is configured to observe in a time window an average signal strength of the input signal on the signal path, and the SoT is detected when the average signal strength is above a predefined threshold.

Observing the average signal strength going from a low signal level to a high signal level and staying high for a certain duration typically triggers the SoT event.

Preferably, the detector is further configured to detect on the signal path an end of transmission, EoT, of the input signal; and send a second trigger signal related to the EoT to the switch controller; and the switch controller is configured to control the power switch to power off the light source after a certain delay upon receiving the second trigger signal, and the certain delay is at least equal to a propagation delay of the input signal traveling from the detector to the light source.

This EoT detection may also be implemented by observing the input signal in a time window large enough to make a robust decision. Going from a high signal level to a low signal level and staying low for a certain duration typically triggers the EoT event.

Alternatively, the switch controller is configured to control the power switch to power off the light source after a predefined maximum packet duration upon receiving the first trigger signal.

The predefined maximum packet duration may be determined according to a maximum packet duration defined in a certain optical wireless communication protocol or standard, or another proprietary protocol related to a certain application.

Optionally, the predefined maximum packet duration is determined by taking an additional delay into account on top of any protocol or standard. The additional delay may be at least covering the settling time of the light source.

In one option, the power switch is placed at an output of a driver of the light source.

Beneficially, the optical transmitter is configured to extend a packet to be transmitted by adding an additional field at the start of the packet; wherein the duration of the additional field is determined according to the first time interval, and the extended packet is sent to the light source as the input signal.

The additional field may comprise a predefined data pattern, such as a repeated preamble of the packet. The additional field may also simply comprise some dummy data.

By amending the packet to be transmitted as a physical-layer extension allows the power switch control without the need for the signal interface, such that the light source will be in a ready state prior to start of the actual data packet. In this way, the input signal is the extended packet, which comprises the data signal, or the actual data packet to be transmitted.

Advantageously, the optical transmitter further comprises a signal interface configured to add an additional delay in the signal path of the optical transmitter before the light source; wherein the additional delay is determined according to the first time interval.

Preferably, the signal interface is added to the signal path after the point that the detector detects on the signal path and before the light source. In that sense, the switch controller will be able to generate the trigger signal before the actual data is propagated to the light source. The additional delay is set according to the first time interval, which is eventually determined by the settling time of the light source.

With this option, the input signal may be a conventional data packet, and is identical to the data signal to be transmitted. Thus, the disclosed optical transmitter may comprise or be used in combination with a conventional modem chip for optical wireless communication.

Beneficially, the optical transmitter further comprising an amplifier connected between the signal interface and the light source.

The transmission chain may comprise an amplifier ahead of the light source. The amplifier may also be a pulse amplifier used for modulating the signal. For example, during transmission, the optical transmitter converts the electrical signal into optical signal by modulating the input signal as input to the light source. This may be achieved by varying an output current of the pulse amplifier according to the input signal, which is then provided to the light source as input.

In one option, the signal interface is a delay unit.

As one example, an all-pass filter may be adopted as a delay unit, which introduces a predefined amount of delay to the data path.

In another option, the signal interface is an analog signal multiplexor.

For example, a delay can be introduced to the signal path by using a multiplexor to keep an amplifier input at zero level for the first time interval, which is determined based on a settling time of the light source, and then connect to the incoming input signal for modulating the LED light level.

Advantageously, the data signal is modulated according to intensity modulation.

Intensity modulation (IM) is a kind of modulation in which the optical power output of a light source is varied in accordance with data signal to be transmitted. Recovery of the signal with intensity modulation is usually by direct detection.

Intensity modulation and direct detection (IM/DD) is a cost-effective optical communication strategy which finds wide applications in fibre communication, free-space optical communication, and indoor visible light communication.

In another example, the data signal may also be modulated according to an Orthogonal Frequency-Division Multiplexing, OFDM, scheme.

OFDM is widely used as a digital multi-carrier modulation method in many communication systems, because it has a great advantage of robustness against severe channel conditions, such as narrowband interference or frequency selective fading. By splitting the entire band into a plurality of subcarriers, the system also has the flexibility to apply different modulation and coding schemes to individual subcarriers, which may be used to maximize the capacity of the channel. For optical wireless communication, unipolar OFDM modulation techniques are typically employed, such as ACO-OFDM, DCO-OFDM, ADO-OFDM and/or Flip OFDM.

In accordance with a second aspect of the invention, an optical front-end is provided. An optical front-end configured to transmit a data signal for optical wireless communication, the optical front-end comprises a light source configured to emit light for optical wireless communication based on an input signal comprising the data signal to be transmitted via the optical front-end; a power switch configured to turn on or off a power supply to the light source; a detector configured to: detect the input signal on a signal path of the optical front-end; and send a first trigger signal related to a start of transmission, SoT, of the input signal to a switch controller; the switch controller configured to control the power switch to power on the light source upon receiving the first trigger signal; and a signal interface configured to add an additional delay in the signal path before the light source; wherein the additional delay is determined according to a settling time of the light source.

The signal interface may be either a delay unit or an analog signal multiplexor.

Preferably, the signal interface is added to the signal path after the point that the detector detects on the signal path and before the light source.

With the signal interface deployed in the optical front-end (OFE), it provides a complete solution to the settling time problem of the light source when powering up. In this way, the input signal to the OFE can be a conventional data packet, and is identical to the data signal to be transmitted. Thus, the disclosed OFE may be used in combination of a conventional modem chip for optical wireless communication.

In a further example, a system for optical communication comprises an optical front-end and a modem. The optical front-end comprises a light source configured to emit light for optical wireless communication based on an input signal to be transmitted via the optical front-end; a power switch configured to turn on or off a power supply to the light source; a detector configured to: detect the input signal on a signal path of the optical front-end; and send a first trigger signal related to a start of transmission, SoT, of the input signal to a switch controller; the switch controller configured to control the power switch to power on the light source upon receiving the first trigger signal. The modem is configured to extend a packet to be transmitted by adding an additional field at the start of the packet; wherein the duration of the additional field is determined according to a settling time of the light source of the optical front-end, and the extended packet is sent to the optical front-end as the input signal.

Therefore, in this option, the optical front-end does not have to incorporate a special signal interface to introduce an additional delay in the signal path to compensate the effect of light source settling. Instead, the modem provides the input signal with an additional field or dummy data ahead of the actual data signal/packet to be transmitted. Therefore, data packet transmission will not be impaired due to a slow settling of the light source.

In accordance with a further aspect of the invention, a method for reducing standby power consumption is provided. A method for reducing standby power consumption in an optical transmitter, wherein the optical transmitter (100) is configured to transmit a data signal for optical wireless communication; the method comprises the steps of the optical transmitter: emitting light by a light source for optical wireless communication based on an input signal comprising the data signal to be transmitted via the optical transmitter; turning on or off a power supply to the light source by a power switch; detecting the input signal on a signal path of the optical transmitter; sending a first trigger signal related to a start of transmission, SoT, of the input signal to a switch controller; controlling the power switch to power on the light source upon receiving the first trigger signal; preventing the data signal being transmitted during a first time interval after powering on the light source; and transmitting the data signal during a second time interval subsequent to the first time interval; wherein the first time interval is determined based on a settling time of the light source.

Beneficially, the method further comprises the steps of detecting on the signal path an end of transmission, EoT, of the input signal; sending a second trigger signal related to the EoT to the switch controller; controlling the power switch to power off the light source after a certain delay upon receiving the second trigger signal, and the certain delay is at least equal to a propagation delay of the data signal traveling from the detector to the light source.

Alternatively, the method further comprises a step of controlling the power switch to power off the light source after a predefined maximum packet duration upon receiving the first trigger signal.

The predefined maximum packet duration may be determined according to a maximum packet duration defined in a certain optical wireless communication protocol or standard, or another proprietary protocol related to a certain application.

Optionally, the predefined maximum packet duration is determined by taking an additional delay into account on top of any protocol or standard. The additional delay covers at least the settling time of the light source.

### BRIEF DESCRIPTION OF THE DRAWINGS

In the drawings, like reference characters generally refer to the same parts throughout the different figures. Also, the drawings are not necessarily to scale, emphasis instead generally being placed upon illustrating the principles of the invention.

FIG. 1 shows a block diagram of an optical transmitter;

FIG. 2 shows a block diagram of an optical front-end;

FIG. 3 shows an example of an optical transmitter;

FIG. 4 illustrates an example of a packet structure of an input signal;

FIG. 5 shows a block diagram of a system for OWC; and

FIG. 6 shows a flowchart of a method of an optical transmitter.

### DETAILED DESCRIPTION OF EMBODIMENTS

The embodiments set forth below represent information to enable those skilled in the art to practice the embodiments. Upon reading the following description in light of the accompanying drawings, those skilled in the art will understand the concepts of the disclosure and will recognize applications of these concepts not particularly addressed herein. It should be understood that these concepts and applications fall within the scope of the disclosure.

This invention relates to optical wireless communication (OWC), such as LiFi, which is being developed to augment Wi-Fi and other RF communication technologies. In Li-Fi, information is typically communicated by modulating the intensity of light of particular wavelength that illuminates a given area. Transceivers conforming to the chosen wavelength and capable of modulating/demodulating and encoding/decoding signals are used to realize the OWC link.

One of the critical aspects of a LiFi communication system is the power consumption of the OFEs. Primarily, the transmitter part consumes considerable amount of power (few Watts) in order to generate sufficient signal-to-noise ratio (SNR) at the receiver side for good data throughput (100 Mb/s or more). If the LiFi communication were to be combined with normal illumination, the transmit power requirement could be ignored.

However, due to the slow modulation speed of LEDs used in normal illumination and the difficulty of integrating the data modulator with the LED driver, it is normal practice to use a separate communication LED unit, mostly in the infrared (IR) wavelength. While this separation has an additional advantage of not requiring the normal illumination to be active for data communication purposes, it however increases the overall power consumption. As standby power is becoming a concern, especially when related to lighting networks, it is of interest to look into methods that address this issue.

A typical LiFi communication system may have a number of optical front-ends (OFEs) that realize the transceiver functionality by interfacing optical and electrical signal transmission domains. The ceiling OFEs may act as distributed access points (AP1 . . . APn), each covering part of the scene. The mobile end-ponit OFEs (EP) represent user-side interface devices for the LiFi link, which has a field of view that covers at least one of the APs. The APs may be connected to the modem and network interface using copper or fiber cable connections.

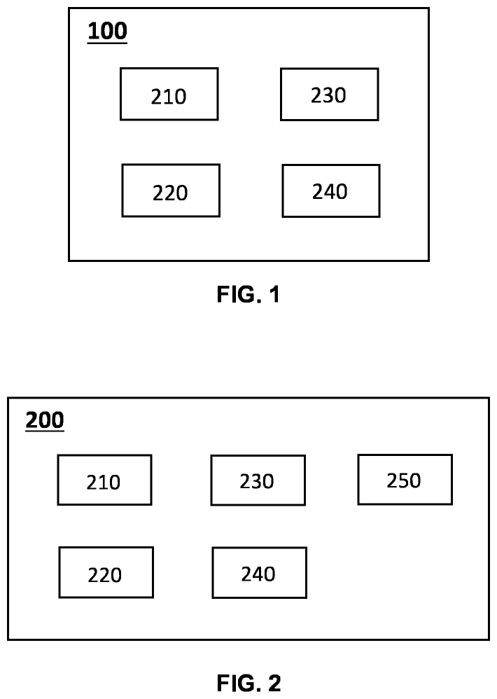

FIG. 1 shows a block diagram of an optical transmitter 100. As a basic setup, the optical transmitter 100 comprises a light source 210, a power switch 220, a detector 230, and a switch controller 240. The light source 210 is configured to emit light for optical wireless communication based on an input signal, which comprises a data signal to be transmitted via the optical transmitter 100. The power switch 220 is configured to turn on or off a power supply to the light source 210. The detector 230 is configured to detect the input signal on a signal path of the optical transmitter 100, and to send a first trigger signal related to a start of transmission (SoT) of the input signal to a switch controller 240. The switch controller 240 configured to control the power switch 220 to power on the light source 210 upon receiving the first trigger signal. The optical transmitter 100 is configured to prevent the data signal being transmitted during a first time interval after powering on the light source 210; and transmit the data signal during a second time interval subsequent to the first time interval. The first time interval is determined based on a settling time of the light source 210.

The light source 210 is the most power consuming component in an optical transmitter 100, and thus it is important to keep the light source 210 in a sleep mode as long as possible from a power efficiency point of view. However, due to the latency required for the light source 210 from being powering up till settling at an output level suitable for optical wireless communication, it is necessary to have a mechanism to allow the light source 210 to settle before the actual data signal arrives. The detector 230 and switch controller 240 are used to achieve this purpose. The detector 230 detects the input signal on the signal path at a point ahead of the light source 210, and thus informs the switch controller 240 to control the power switch 220 accordingly. In this way, the actual data signal arrives at the light source 210 when it is already settled, which allows the data signal to be transmitted with a suitable output level of the light source.

FIG. 2 shows a block diagram of an optical front-end 200. The optical front end 200 comprises a light source 210, a power switch 220, a detector 230, a switch controller 240, and a signal interface 250. The light source 210 is configured to emit light for optical wireless communication based on an input signal comprising a data signal to be transmitted via the optical front end 200. The power switch 220 is configured to turn on or off a power supply to the light source 210. The detector 230 is configured to detect the input signal on a signal path of the optical front end 200; and to send a first trigger signal related to a start of transmission (SoT) of the input signal to the switch controller 240. The switch controller 240 is configured to control the power switch 220 to power on the light source 210 upon receiving the first trigger signal. The signal interface 250 is configured to add an additional delay in the signal path before the light source 210; wherein the additional delay is determined according to a settling time of the light source 210.

By deploying the signal interface 250 in the optical front-end (OFE), the problem of settling time due to light source powering up is solved inside the OFE completely. The input signal to the OFE may be a normal data packet, and is identical to the data signal to be transmitted. Thus, the disclosed OFE may be used in combination of a conventional modem chip for OWC.

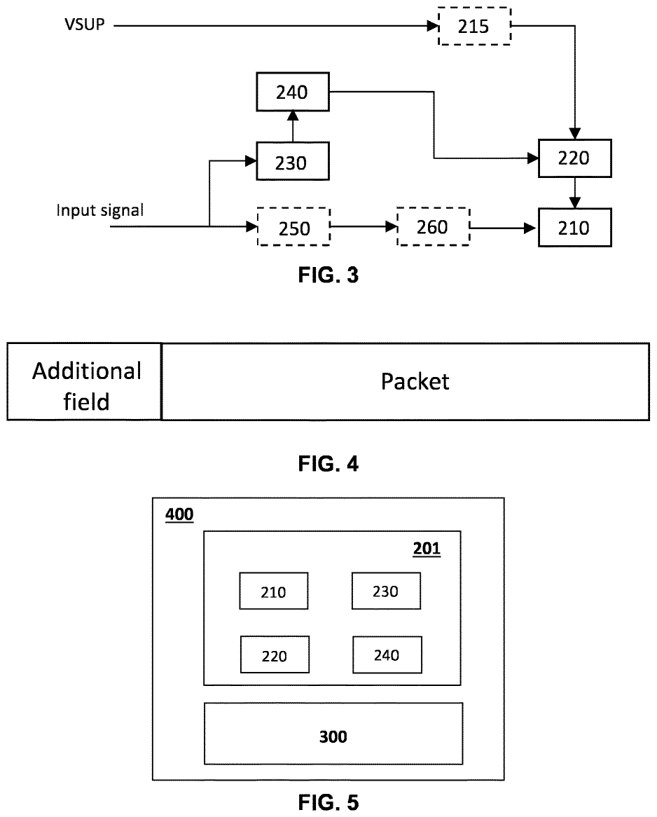

FIG. 3 shows an implementation example of an optical front-end (OFE) 200. In this example, during transmission the OFE 200 converts the electrical signal into optical signal by modulating the LED current (ILED) by varying the pulse amplifier 260 output current (IMOD) according to the input signal. A power switch (PS) 220 is introduced on the LED supply line VCUP to switch off light generation when there is no data transmission and thereby reduce associated power consumption. The power switch 220 is driven by a switch controller (SC) 240 that is triggered by a detector 230, which is used to detect the start-of-transmission (SoT) and/or end-of-transmission (EoT). A signal interface unit (SI) 250 is introduced to provide a pre-defined interval to allow the LED 210 to settle at the average output level which will be used by the receiving optical frontend OFE to establish a reference DC level for decoding the OFDM modulation. To reduce the settling time of the LED driver 215, the power switch 220 is placed at the output so that the driver 215 starts at a state close to normal transmission mode when a signal to be transmitted arrives. Placing the power switch 220 at the input of the LED driver 215 would lead to loss of internal state (e.g., discharging of capacitors) resulting in long start up time. Although the pulse amplifier 260 sinks or sources large IMOD currents during data transmission, its bias current during standby mode could be low and may not need to be switched off.

For signals modulated with OFDM, various carrier signals are amplitude modulated according to allocated data bits. Since signal levels before start of transmission and during transmission are distinguishable, a comparator with proper threshold can be used to detect start-of-transmission and end-of-transmission. This SoT/EoT detection may be done by observing the input signal in a window large enough to make a robust decision. For example, going from a low signal level to a high signal level triggers the SoT event while going from a high signal level to a low signal level and staying low for a certain time period triggers the EoT event.

When receiving a SoT trigger signal, the switch controller 240 dispatches control signals to the power switch 220 to start delivering power to the pulse amplifier 260 and LED module 210. When an EoT trigger signal is received, the switch controller 240 schedules a switch-OFF command to take place after a waiting interval long enough to let all the delayed TX signal to be transmitted via the LED 210. The switch controller 240 can optionally use a timer that will keep the switches active for the longest possible packet size and avoid EoT detection. However, since actual packet lengths can be different and usually less than the longest possible packet size, a fixed switch-ON interval will be less effective in power saving compared to EoT based switch control.

The signal interface unit (SI) 250 can be realized as delay unit, e.g., using an all-pass filter which introduces a predefined amount of delay to all subcarriers in the OFDM signal. Since the pulse amplifier 260 and LED 210 have fast response, the amount of delay required is rather small implying that a few components typically suffice to realize the delay. Another option which doesn't need a delay unit is to keep the amplifier input at zero level for a short duration after arrival of SoT detection, so that the LED output light level settles at the average (DC) level, and then connect to the incoming TX signal for modulating the LED light level. This option can be implemented as an analog signal multiplexor.

The above scheme can be implemented alternatively by explicitly providing a dedicated start-of-transmission signal prior to the normal packet preamble to enable power control of the OFEs. Such physical-layer extension will allow power switch control without the need for signal delay, as the OFEs will be put in their ready state prior to start of the normal packet. FIG. 4 illustrates an example of a packet structure of such an input signal. An additional field is added to a normal data packet. When we talk about a standard compliant system, this option indicates a PHY layer extension of a data frame, such as according to G.VLC (G.9991), with an extra preamble interval for standby control. During this interval, a predefined signal is sent to the OFEs to generate the SoT trigger. The data in the additional field, or so called a Standby Control section, can simply be an extension of the original preamble signal of the data frame which is originally meant for synchronization purposes. Such an extension can possibly be implemented in current chipsets as a firmware update to increase the length of the preamble.

FIG. 5 shows a block diagram of a system 400 for optical wireless communication. As a basic setup, the system 400 comprises an optical front-end 201 and a modem 300. The optical front-end 201 comprises a light source 210, a power switch 220, a detector 230, and a switch controller 240. The light source 210 is configured to emit light for optical wireless communication based on an input signal to be transmitted via the optical front-end 201. The power switch 220 is configured to turn on or off a power supply to the light source 210. The detector 230 is configured to detect the input signal on a signal path of the optical front-end 201; and send a trigger signal related to a start of transmission, SoT, of the input signal to the switch controller 240. The switch controller 240 is configured to control the power switch 220 to power on the light source 210 upon receiving the first trigger signal. The modem 300 is configured to extend a packet to be transmitted by adding an additional field at the start of the packet, as depicted in FIG. 3. The duration of the additional field is determined according to a settling time of the light source 210 of the optical front-end 201, and the extended packet is sent to the optical front-end 201 as the input signal.

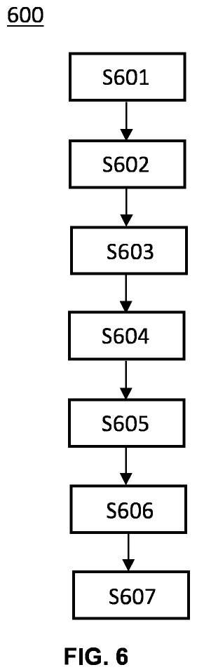

FIG. 6 shows a flowchart of a method 600 of an optical transmitter 100. The method 600 comprises the following steps of the optical transmitter 100: emitting light in step S601 by a light source 210 for optical wireless communication based on an input signal comprising a data signal to be transmitted via the optical transmitter 100; turning in step S602 on or off a power supply to the light source 210 by a power switch 220; detecting in step S603 the input signal on a signal path of the optical transmitter 100; sending in step S604 a first trigger signal related to a start of transmission, SoT, of the input signal to a switch controller 240; controlling in step S605 the power switch 220 to power on the light source 210 upon receiving the first trigger signal; in step S606, preventing the data signal being transmitted during a first time interval after powering on the light source 210; and transmitting in step S607 the data signal during a second time interval subsequent to the first time interval. The first time interval is determined based on a settling time of the light source 210.

The methods according to the invention may be implemented on a computer as a computer implemented method, or in dedicated hardware, or in a combination of both.

Executable code for a method according to the invention may be stored on computer/machine readable storage means. Examples of computer/machine readable storage means include non-volatile memory devices, optical storage medium/devices, solid-state media, integrated circuits, servers, etc. Preferably, the computer program product comprises non-transitory program code means stored on a computer readable medium for performing a method according to the invention when said program product is executed on a computer.

Methods, systems, and computer-readable media (transitory and non-transitory) may also be provided to implement selected aspects of the above-described embodiments.

1. An optical transmitter configured to transmit a data signal for optical wireless communication, the optical transmitter comprising:
a light source configured to emit light for optical wireless communication based on an input signal comprising the data signal to be transmitted via the optical transmitter;
a power switch configured to turn on or off a power supply to the light source;
a detector configured to:
detect the input signal on a signal path of the optical transmitter; and
send a first trigger signal related to a start of transmission, SoT, of the input signal to a switch controller;
the switch controller configured to control the power switch to power on the light source upon receiving the first trigger signal;
wherein the optical transmitter is configured to:
prevent the data signal being transmitted during a first time interval after powering on the light source; and
transmit the data signal during a second time interval subsequent to the first time interval;
wherein the first time interval is determined based on a settling time of the light source.

2. The optical transmitter of claim 1, wherein the detector is configured to observe in a time window an average signal strength of the input signal on the signal path, and the SoT is detected when the average signal strength is above a predefined threshold.

3. The optical transmitter of claim 1, wherein the detector is further configured to:
detect on the signal path an end of transmission, EoT, of the input signal; and
send a second trigger signal related to the EoT to the switch controller; and the switch controller is configured to:
control the power switch to power off the light source after a certain delay upon receiving the second trigger signal, and the certain delay is at least equal to a propagation delay of the input signal traveling from the detector to the light source.

4. The optical transmitter of claim 1, wherein the switch controller is configured to
control the power switch to power off the light source after a predefined maximum packet duration upon receiving the first trigger signal.

5. The optical transmitter of claim 1, wherein the power switch is placed at an output of a driver of the light source.

6. The optical transmitter of claim 1, the optical transmitter configured to extend a packet to be transmitted by adding an additional field at the start of the packet; wherein the duration of the additional field is determined according to the first time interval, and the extended packet is sent to the light source as the input signal.

7. The optical transmitter of claim 1, the optical transmitter further comprising a signal interface configured to add an additional delay in the signal path of the optical transmitter before the light source; wherein the additional delay is determined according to the first time interval.

8. The optical transmitter of claim 7, the optical transmitter further comprising an amplifier connected between the signal interface and the light source.

9. The optical transmitter of claim 7, wherein the signal interface is a delay unit.

10. The optical transmitter of claim 7, wherein the signal interface is an analog signal multiplexor.

11. The optical transmitter of claim 1, wherein the data signal is modulated according to intensity modulation.

12. An optical front-end configured to transmit a data signal for optical wireless communication, the optical front-end comprising:
a light source configured to emit light for optical wireless communication based on an input signal comprising the data signal to be transmitted via the optical front-end;
a power switch configured to turn on or off a power supply to the light source;
a detector configured to:
detect the input signal on a signal path of the optical front-end; and
send a first trigger signal related to a start of transmission, SoT, of the input signal to a switch controller;
the switch controller configured to control the power switch to power on the light source upon receiving the first trigger signal; and
a signal interface configured to add an additional delay in the signal path before the light source; wherein the additional delay is determined according to a settling time of the light source.

13. A method for reducing standby power consumption in an optical transmitter, wherein the optical transmitter is configured to transmit a data signal for optical wireless communication; the method comprising the optical transmitter:
emitting light by a light source for optical wireless communication based on an input signal comprising the data signal to be transmitted via the optical transmitter;
turning on or off a power supply to the light source by a power switch;
detecting the input signal on a signal path of the optical transmitter;
sending a first trigger signal related to a start of transmission, SoT, of the input signal to a switch controller;
controlling the power switch to power on the light source upon receiving the first trigger signal;
preventing the data signal being transmitted during a first time interval after powering on the light source; and
transmitting the data signal during a second time interval subsequent to the first time interval;
wherein the first time interval is determined based on a settling time of the light source.

14. The method of claim 13, the method further comprising:
detecting on the signal path an end of transmission, EoT, of the input signal;
sending a second trigger signal related to the EoT to the switch controller; and
controlling the power switch to power off the light source after a certain delay upon receiving the second trigger signal, and the certain delay is at least equal to a propagation delay of the data signal traveling from the detector to the light source.

15. The method of claim 13, the method further comprising:
controlling the power switch to power off the light source after a predefined maximum packet duration upon receiving the first trigger signal.
